(19) United States
(12) Patent Application Publication
(10) Pub. No.: US 2024/0219671 A1
(43) Pub. Date: Jul. 4, 2024

(54) SPLITTER MODULE ASSEMBLY FOR MULTIPLE DWELLING UNITS

(71) Applicant: CORNING RESEARCH & DEVELOPMENT CORPORATION, Corning, NY (US)

(72) Inventors: Chad Lee German, Haslet, TX (US); Mitchell Harold Stewart, Lincolnton, NC (US)

(21) Appl. No.: 18/155,896

(22) Filed: Jan. 18, 2023

Related U.S. Application Data
(60) Provisional application No. 63/435,866, filed on Dec. 29, 2022.

(51) Int. Cl. G02B 6/44

(52) U.S. Cl. CPC G02B 6/4472

(57) ABSTRACT

The present disclosure relates to a splitter module assembly where splitter modules are configured with multi-fiber distribution connectors such that improved output fiber utilization/termination results.

### PRIORITY APPLICATION

This application claims the benefit of priority of U.S. Provisional Application No. 63/435,866, filed on Dec. 29, 2022, the content of which is relied upon and incorporated herein by reference in its entirety.

### FIELD OF THE INVENTION

The present invention is related to splitter devices, and more particularly, to splitter devices with multi-fiber connector distributions.

### BACKGROUND OF THE INVENTION

Optical fibers are useful in a wide variety of applications, including the telecommunications industry for voice, video, and data transmissions. The benefits of optical fiber are well known and include higher signal-to-noise ratios and increased bandwidth compared to conventional copper-based transmission technologies. To meet modern demands for increased bandwidth and improved performance, telecommunication networks are increasingly providing optical fiber connectivity closer to end subscribers. These initiatives include fiber-to-the-node (FTTN), fiber-to-the-premises (FTTP), fiber-to-the-home (FTTH), and the like (generally described as FTTx).

In an FTTx network, fiber optic cables are used to carry optical signals to various distribution points and, in some cases, all the way to end subscribers. For example, FIG. 1 is a schematic diagram of an exemplary FTTx network 10 that distributes optical signals generated at a switching point 12 (e.g., a central office of a network provider) to subscriber premises 14. Optical line terminals (OLTs; not shown) at the switching point 12 convert electrical signals to optical signals. Fiber optic feeder cables 16 then carry the optical signals to various local convergence points 18, which act as locations for splicing and making cross-connections and interconnections. The local convergence points 18 often include splitters to enable any given optical fiber in the fiber optic feeder cable 16 to serve multiple subscriber premises 14. As a result, the optical signals are “branched out” from the optical fibers of the fiber optic feeder cables 16 to optical fibers of distribution cables 20 that exit the local convergence points 18.

At network access points closer to the subscriber premises 14, some or all of the optical fibers in the distribution cables 20 may be accessed to connect to one or more subscriber premises 14. Drop cables 22 extend from the network access points to the subscriber premises 14, which may be single-dwelling units (SDU), multi-dwelling units (MDU), businesses, and/or other facilities or buildings. A conversion of optical signals back to electrical signals may occur at the network access points or at the subscriber premises 14.

There are many different network architectures, and the various tasks required to distribute optical signals (e.g., splitting, splicing, routing, connecting subscribers) can occur at several locations. Regardless of whether a location is considered a local convergence point, network access point, subscriber premise, or something else, fiber optic equipment is used to house components that carry out one or more of the tasks. The term “terminal” will be used in this disclosure to generically refer to such equipment, which may include fiber distribution hubs (FDH), cabinets, closures, network interface devices, etc.

Terminals at locations that split optical signals typically include splitter modules for this task. Each splitter module includes at least one input fiber whose signals are split between a plurality of output fibers. Conventional splitter modules, such as Planar Lightweight Circuit (PLC) splitter modules, are generally rectangular in shape with the input and output fibers located on one side thereof. Such splitter modules are typically mounted in the terminal using hooks, screws, or other fasteners.

Space is often at a premium in terminals, especially when the terminals include a large number of components and cables. Accommodating splitter modules can be challenging when designing a terminal, particularly when a fairly large quantity, such as dozens or hundreds, of optical fibers are involved. The space within a terminal is typically limited because there is also a need to properly route and store cables, to accommodate components for splicing, storing unused connectors, or the like, and to allow technicians to effectively install or operate the components. Making terminals larger may not necessarily help with organization and may increase the likelihood of customers considering the equipment to be obtrusive.

Conventional splitter module mounting techniques fail to provide space-efficient mounting. For example, conventional splitter modules are configured in a variety of particular shapes and sizes, and with various different mounting features, such that each splitter module to be positioned within a terminal may have a unique footprint requiring a unique positioning, orientation, and/or mounting hardware which may interfere with adjacent splitter modules or other components. This can result in a complex, disordered arrangement of splitter modules and their associated fibers that can be difficult to manage in the relatively small space provided by the terminal.

Moreover, with increasing optical fiber access worldwide and the deployment of fiber to the X (FTTX) architectures, more and more subscribers are being added into networks. Consequently, an increased demand is arising for signal splitting products. At the same time, adding more splitter modules consumes more space in hubs or nodes.

Therefore, there is a continued need to improve the fiber utilization within the splitter modules to improve total utilization of the splitter modules and corresponding output fibers.

### BRIEF SUMMARY OF THE INVENTION

Various embodiments described herein relate to fiber optic splitter modules, such as those used in various fiber optic applications. In general, the present disclosure relates to a splitter module assembly where splitter modules are configured with multi-fiber distribution connectors such that improved output fiber utilization/termination results.

In one embodiment, a splitter module assembly for use within a terminal is provided. The splitter module comprising: a first splitter module having a first plurality of output optical fibers; a second splitter module having a second plurality of output optical fibers; wherein a portion of the first plurality of output optical fibers is terminated by a first connector; and wherein a portion of the second plurality of output optical fibers is terminated by the first connector, thereby connecting the first splitter module and the second splitter module.

In another embodiment, the splitter module assembly, further comprising: a third splitter module having a third plurality of output optical fibers; wherein a second portion of the second plurality of output optical fibers is terminated by a second connector; and wherein a portion of the third plurality of output optical fibers is terminated by the second connector, thereby connecting the second splitter module and the third splitter module. In another embodiment, a remainder of the first plurality of output optical fibers are terminated by at least a third connector; and wherein a remainder of the third plurality of output optical fibers are terminated by at least a fourth connector. In another embodiment, the first, second, third, and fourth connectors comprise multifiber connectors that terminate all of the output optical fibers of the first, second, and third splitter modules are terminated. In another embodiment, the multifiber connectors comprise MPO connectors.

In one embodiment, a splitter module assembly for use within a terminal is provided. The splitter module assembly comprising: a splitter module comprising a plurality of output optical fibers; wherein a first portion of the plurality of output optical fibers is terminated by at least a first connector; and wherein a second portion of the plurality of output optical fibers is terminated by at least a second connector; wherein the first connector comprises a multifiber connector, and each second connector of the at least a second connector comprises a single fiber connector, whereby the plurality of output optical fibers are terminated by the first and the at least a second connector.

In another embodiment, the at least a second connector comprises a plurality of single fiber connectors, wherein the plurality of single fiber connectors terminate all optical fibers in the second portion of the plurality of optical fibers. In another embodiment, the at least a first connector comprises a plurality of multifiber connectors, wherein the plurality of multifiber connectors terminate all optical fibers in the first portion of the plurality of optical fibers. In another embodiment, the multifiber connectors comprise MPO connectors. In another embodiment, the splitter module comprises a 1×32 or 1×64 splitter module.

In one embodiment, a splitter module assembly for use within a terminal is provided. The splitter module comprising: a first splitter module having a first plurality of output optical fibers; a second splitter module having a second plurality of output optical fibers; wherein a first portion of the first plurality of output optical fibers is terminated by at least a first connector; wherein a second portion of the first plurality of output optical fibers is terminated by a second connector; wherein a first portion of the second plurality of output optical fibers is terminated by the second connector, thereby connecting the first splitter module and the second splitter module; and wherein a second portion of the second plurality of output optical fibers is terminated by at least a third connector.

In another embodiment, the at least a first connector comprises a plurality of first connectors that terminate all of the optical fibers in the first portion of the first plurality of output optical fibers. In another embodiment, the plurality of first connector and the second connector each comprise a multifiber connector. In another embodiment, the at least a first connector and the second connector each comprise an MPO connector. In another embodiment, the at least a third connector comprises a plurality of third connectors, wherein the plurality of third connectors terminate the second portion of the second plurality of output optical fibers. In another embodiment, the plurality of third connectors comprises single fiber connectors, wherein the single fiber connectors individually terminate respective optical fibers of the second portion of the second plurality of output optical fibers.

### BRIEF DESCRIPTION OF THE DRAWINGS

Having thus described the invention in general terms, reference will now be made to the accompanying drawings, which are not necessarily drawn to scale and are meant to be illustrative and not limiting, and wherein:

FIG. 1 is a schematic diagram of an example FTTx network;

FIG. 2 is a perspective view of one embodiment of a terminal;

FIG. 3 is a perspective view of an alternate terminal in accordance with the present disclosure;

FIG. 4 is a perspective view of a further alternate terminal in accordance with the present disclosure;

FIG. 5A is a perspective view illustrating an example optical splitter assembly to be used in accordance with the terminals as described herein in accordance with the present disclosure;

FIG. 5B is a perspective view illustrating various components installed within the optical splitter module of FIG. 5A, where a top cover of the optical splitter module is removed, in accordance with some embodiments discussed herein;

FIG. 6 is a schematic representation of a splitter module assembly illustrating the termination of the output fibers of the splitter module of FIGS. 5A, 5B in accordance with the present disclosure; and

FIG. 7 is a schematic representation of a splitter module assembly illustrating the termination of output fibers of the splitter module of FIGS. 5A, 5B in accordance with the present disclosure.

### DETAILED DESCRIPTION OF THE INVENTION

Various embodiments will be further clarified by examples in the description below. In general, the present disclosure relates to a splitter module assembly where splitter modules are configured with multi-fiber distribution connectors such that improved output fiber utilization/termination results.

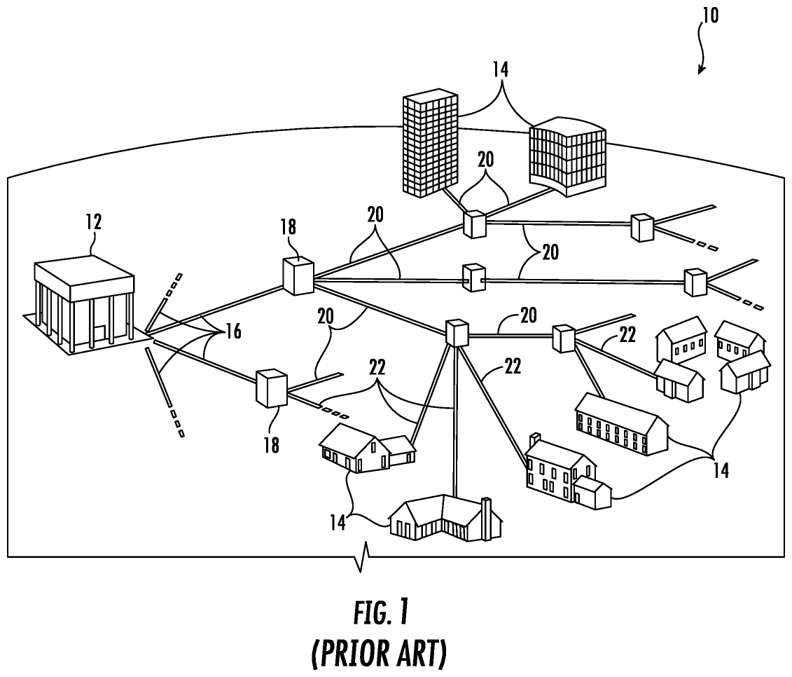

The components may be used in FTTx networks, such as the FTTx network 10 (FIG. 1) such as in terminals at local convergence points 18 or network access points, or even in enterprise networks, such as in data center environments. Thus, although the components may be described in connection with an exemplary terminal below, this is merely to facilitate discussion. The components may in fact be used in a wide variety of different equipment for all different types of fiber optic networks.

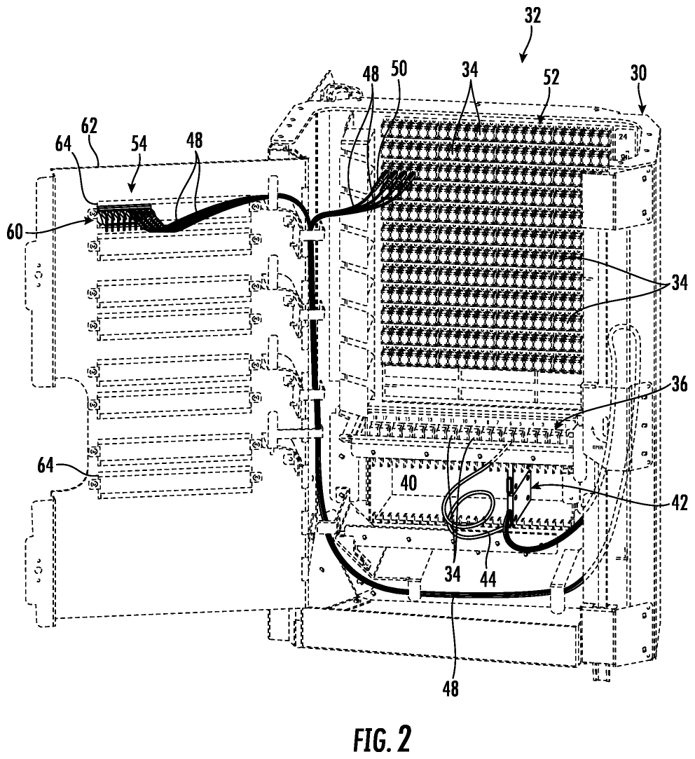

With this in mind, FIG. 2 illustrates one example of frame 30 for a terminal 32 to be placed at one of the local convergence points 18 in FIG. 1. The terminal 32 may be in the form of a cabinet or enclosure that includes the frame 30 installed in a housing (not shown). The frame 30 supports various components for accomplishing the network tasks associated with the local convergence point 18. For example, a row of fiber optic adapters 34 supported by the frame 30 defines a “feeder field” 36 to receive connections associated with one of the feeder cables 16 of the network 10. Optical fibers (not shown) from the feeder cable 16 may be terminated with fiber optic connectors (directly or by splicing to pigtails) that are plugged into the fiber optic adapters 34 on the back side of the frame 30.

Below the feeder field 36, the frame 30 defines one or more slots 40 for receiving and supporting splitter modules 42. Only two splitter modules 42 are shown in FIG. 2, and only the splitter module 42 on the bottom is schematically illustrated with an input cable 44 and a plurality of output cables 48 to simplify the drawings. The input cable 44 carries an input fiber (not shown), and the output cables 48 carry respective output fibers (not shown). The splitter modules 42 each include an optical splitter (not shown) so that a multiplexed signal carried by the input fiber of the input cable 44 can be separated into demultiplexed signals carried by the output fibers of the output cables 48. The multiplexed signal typically comes from the feeder cable 16 (FIG. 1). To this end, the input cable 44 of the splitter module 42 may be terminated with a fiber optic connector (not shown in FIG. 2) and plugged into the front side of the fiber optic adapters 34 in the feeder field 36, thereby establishing optical connections with optical fibers of the feeder cable 16.

The number of output fibers (and corresponding output cables 48) of each splitter module 42 depends on the split ratio (e.g., 1 input fiber and 8 output fibers for a 1×8 splitter, 1 input fiber and 16 output fibers for a 1×16 splitter, 1 input fiber and 32 output fibers for a 1×32 splitter, etc.). Output cables 48 that are “live” (i.e., used in the network to carry signals to and from subscribers) are plugged into the front side of fiber optic adapters 34 in a distribution field 52. There are typically several or many rows of adapters 34 defining the distribution field 52. These adapters 34 are used to establish optical connections with optical fibers of one or more distribution cables 20 that exit the terminal and carry signals further into the network 10 so that ultimately the signals can reach subscribers.

Conventionally, the output cables 48 that are not used for live network traffic, and instead are reserved for future subscribers, are routed to a storage location 54 (also referred to as a parking field 54). FIG. 2 illustrates four output cables 48 terminated with respective fiber optic connectors 50 (“connectors 50”) that are held within a parking device 60. The parking device 60 is mounted to a door panel 62 of the frame 30 via a mounting structure 64.

As can be appreciated, populating the slots 40 with splitter modules 42 having various footprints (e.g., peripheral shapes and sizes) and other differing mounting considerations (e.g., mounting hardware) can lead to undesirable crowding and an inefficient use of the relatively small space provided by the slots 40. In one embodiment of the invention, the splitter modules 42 are configured with one or more interlocking features for stacking multiple splitter modules 42 together and/or for installing the splitter modules 42 in the terminal 32 in a highly space-efficient manner, thereby allowing for higher densities of splitter modules 42 in the terminal 32.

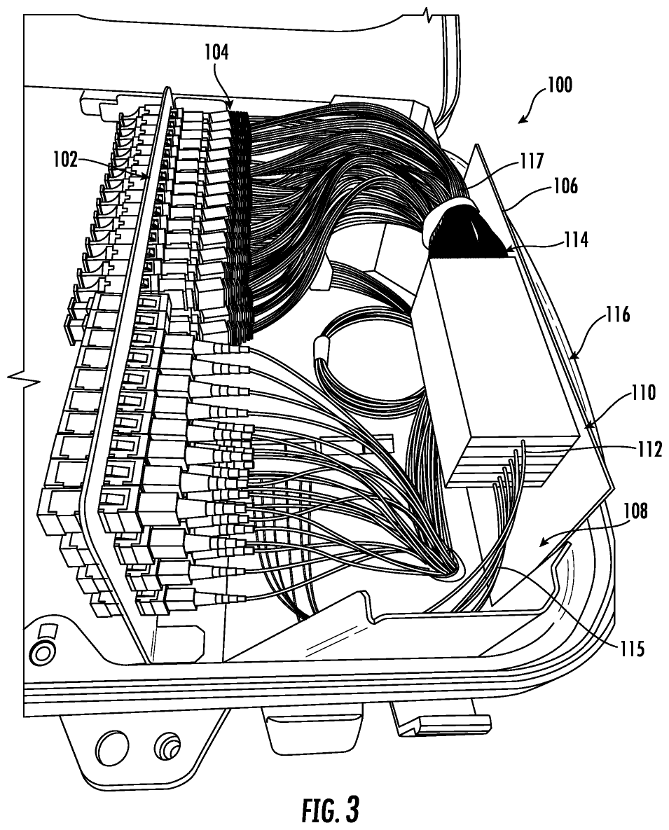

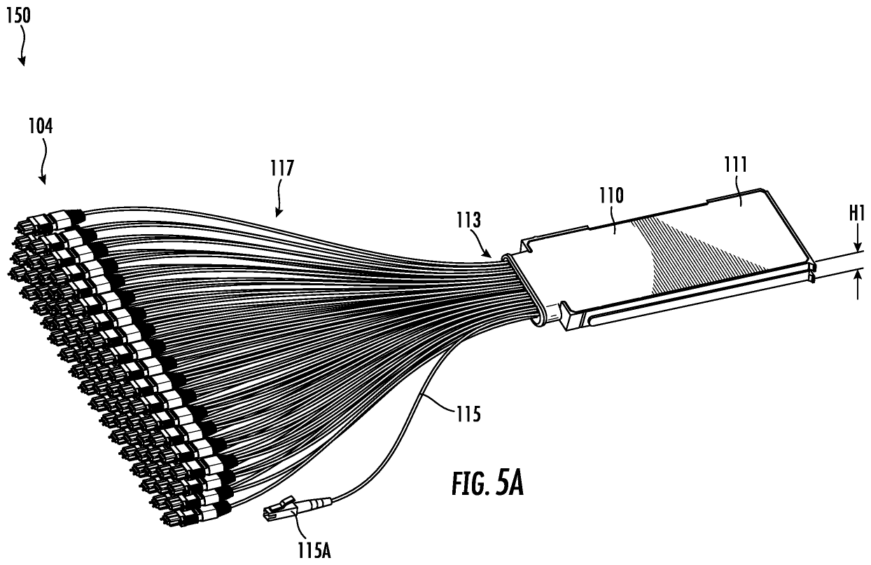

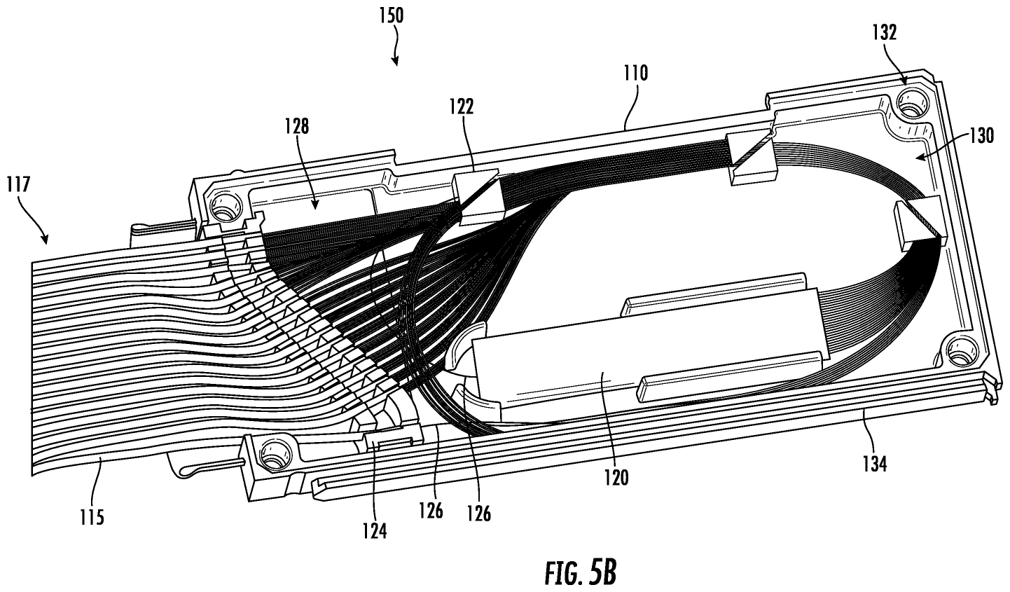

Referring now to FIG. 3, another example terminal 100 is shown. Terminal 100 includes a plurality of multi-fiber receptacles 102 adapted to received multi-fiber connectors 104 of the subscriber optical fibers. In some embodiments, multi-fiber connectors 104 comprise various types of connectors such as SC, LC, MPO, etc. Housing 106 of terminal 100 defines an interior cavity 108 into which a plurality of splitter modules 110 may be received. Rather than providing a cable assembly as in the embodiments discussed above, terminal 100 is adapted to house a plurality of splitter modules 110. The splitter modules 110 of the illustrated embodiments includes a single input opening 112 and a plurality of output openings 114 to which optical fibers may be routed and connected via multi-fiber connectors as discussed in greater detail herein. The optical fibers pass through the openings 112 and 114 similar to the embodiments described herein; however, it would be possible to change the routing if desired by the technician. The splitter modules 110 include at least one splitter that splits the optical signal received through the input opening 112 to the plurality of receptacles of the output openings. The splitter modules 112 are installed by fastening them to brackets 116 provided in the interior cavity 108 of the housing 106; however, further embodiments may install the splitter modules in alternative fashions, such as by providing a splitter end of a cable assembly wherein the splitter end is adapted to receive at least one splitter module within the splitter end, to describe one non-limiting example. Terminal 100 includes an access cover 118 to limit access to the splitter modules to technicians. The splitter modules of certain embodiments of the present invention include the splitter modules of FIGS. 5A and 5B described in more detail below.

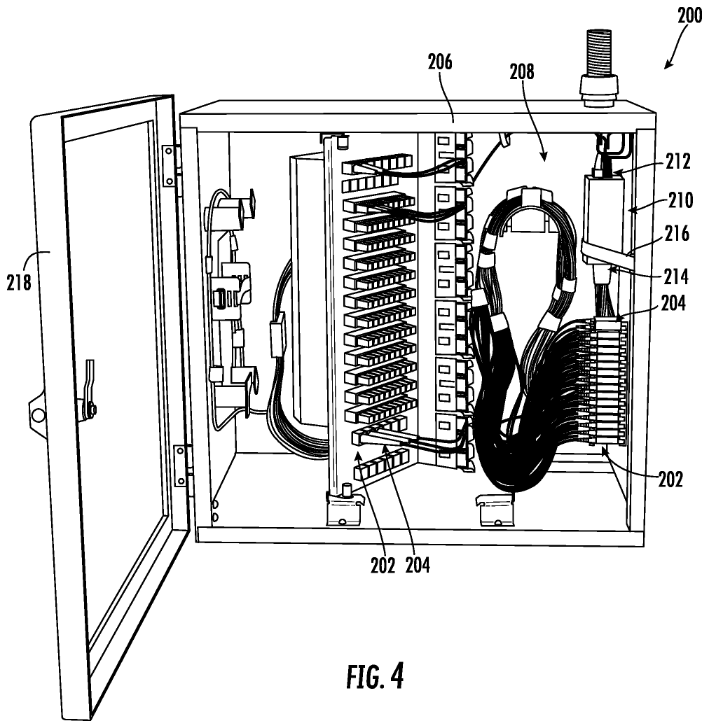

Similarly, with reference to FIG. 4, another example terminal 200 is shown. Terminal 200 includes a plurality of multi-fiber receptacles 202 adapted to received multi-fiber connectors 204 of the subscriber optical fibers. In some embodiments, multi-fiber connectors 204 comprise various types of connectors such as SC, LC, MPO, etc. Housing 206 of terminal 200 defines an interior cavity 208 into which a plurality of splitter modules 210 may be received. Rather than providing a cable assembly as in the embodiments discussed above, terminal 200 is adapted to house a plurality of splitter modules 210. The splitter modules 210 of the illustrated embodiments includes a single input opening 212 and a plurality of output openings 214 to which optical fibers may be routed and connected via multi-fiber connectors as discussed in greater detail herein. The optical fibers pass through the openings 212 and 214 similar to the embodiments described herein; however, it would be possible to change the routing if desired by the technician. The splitter modules 212 include at least one splitter that splits the optical signal received through the input opening 212 to the plurality of receptacles of the output openings. The splitter modules 212 are installed by fastening them to brackets 216 provided in the interior cavity 208 of the housing 206; however, further embodiments may install the splitter modules in alternative fashions, such as by providing a splitter end of a cable assembly wherein the splitter end is adapted to receive at least one splitter module within the splitter end, to describe one non-limiting example. Terminal 200 includes an access cover 218 to limit access to the splitter modules to technicians. The splitter modules of certain embodiments of the present invention include the splitter modules of FIGS. 5A and 5B described in more detail below.

Various optical splitter assemblies are provided herein having optical splitter modules with high optical fiber densities. FIGS. 5A-5B illustrate various features of an example optical splitter assembly 150. The optical splitter assembly 150 includes an optical splitter module 110, and this optical splitter module 110 includes a top cover 111. The optical splitter module 110 may comprise a housing having a volume. The optical splitter module 110 possesses a height (H1), and this height (H1) is approximately 0.40 inches in the illustrated embodiment. However, the height (H1) may possess other values. The optical splitter module 110 also possesses an exit cavity 113, and the exit cavity 113 allows a covered input optical fiber 115 and covered output optical fibers 117 to extend into the optical splitter module 110. The covered input optical fiber 115 may include an input connector 115A at an end of the covered input optical fiber 115, and the covered output optical fibers 117 may include output connectors 104 at the end of the covered output optical fibers 117. In some embodiments, input connector 115A comprises various types of connectors such as SC, LC, MPO, etc. In some embodiments, output connectors 104 comprise various types of connectors such as SC, LC, MPO, etc.

FIG. 5B is a perspective view illustrating various components installed within the optical splitter module 110 of FIG. 5A where a top cover 111 (FIG. 5A) of the optical splitter module 110 is removed. A splitter device 120, routing guides 122, and a fanout device 124 is provided in the optical splitter module 110. In some embodiments, the fanout device 124 may be integrally attached to the optical splitter module 110, but the fanout device 124 may be removably attachable to the optical splitter module 110 in other embodiments. The fanout device 124 may comprise a wide variety of materials. For example, the fanout device 124 may include a polymer material, a plastic material, or some other material. Protrusions within the optical splitter module 110 may assist in positioning the splitter device 120 in the appropriate position. The splitter device 120, the routing guides 122, and the fanout device 124 may be secured to the optical splitter module 110 in some embodiments. For example, the splitter device 120 may be secured to the optical splitter module 110 using fasteners such as adhesive, screws, snap fit tools, etc. The splitter device 120 may be configured to split an input signal from the input optical fiber 126 into a plurality of output signals that are each directed into one of the plurality of output optical fibers 128. In some embodiments, the input optical fiber 126 and the plurality of output optical fibers 128 may be bend insensitive fibers. The input optical fiber 126 and the plurality of output optical fibers 128 may possess a minimum bending radius of approximately 5 millimeters or less in some embodiments. Further, the input optical fiber 126 and the plurality of output optical fibers 128 may include bend performance fibers. The input optical fiber 126 and the plurality of output optical fibers 128 may include a bend performance fiber such as an ITU-T G.657.B3 fiber. The ITU-T G.657.B3 fiber has a minimum bending radius or a macro bend of approximately 5 millimeters (accounting for standard tolerances in measuring the minimum bending radius) and has an induced loss of ≤0.1 decibels per turn at a wavelength of 1550 nanometers.

In the illustrated embodiment, a covered input optical fiber 115 and covered output optical fibers 117 are illustrated. The covered input optical fiber 115 includes an input optical fiber 126 with protective tubing around the input optical fiber 115, and the covered output optical fibers 117 each include an output optical fiber 128 with protective tubing around the output optical fiber 117.

The covered input optical fiber 115 and the covered output optical fibers 117 extend from outside of the optical splitter module 110, through the exit cavity 113, and into the optical splitter module 110. The covered input optical fiber 115 and the covered output optical fibers 117 extend to the fanout device 124. The protective tubing provided in the covered input optical fiber 115 and the covered output optical fibers 117 may be removed for portions of the fibers that are retained within the optical splitter module 110. Thus, the input optical fiber 126 and the output optical fibers 128 may be provided without any protective tubing in certain portions of the internal volume 130 of the optical splitter module 110. By doing so, the internal volume 130 required to hold the optical fibers may be reduced. Furthermore, removal of protective tubing may further reduce the minimum bending radius for the optical fibers, and this may also permit a reduction in the size of the internal volume 130 of the optical splitter module 110.

The input optical fiber 126 and the output optical fibers 128 may be routed within the internal volume 130 of the optical splitter module 110 using the routing guides 122. The routing guides 122 may comprise rubber material in some embodiments, but a wide variety of materials may be used for the routing guides 122. As illustrated, multiple routing guides 122 may be provided in the internal volume 130 of the optical splitter module 110 to route the fibers as desired.

The input optical fiber 126 and output optical fibers 128 are routed to the splitter device 120, and the fibers are connected to the splitter device 120. In the illustrated embodiment, one input optical fiber 126 and sixty-four (64) output optical fibers 128 are connected to the splitter device 120. The input optical fiber 126 may be configured to carry an input signal, and the output optical fibers 128 may each be configured to carry a respective output signal. The splitter device 120 is configured to split signals from the input optical fiber 126 into sixty-four (64) output optical fibers 128.

However, a different number of input optical fibers 126 and output optical fibers 128 may be used in other embodiments. For example, two or more input optical fibers 126 may be used in some embodiments, and thirty-two (32), eighty (80), one hundred twenty-eight (128), or some other number of output optical fibers 128 may be used.

In some embodiments, a splitter device may be configured to split signals from a single input optical fiber into one hundred twenty-eight (128) output optical fibers. Where this is the case, the dimensions of the optical splitter module and the exit cavity may be increased to accommodate the increased number of output optical fibers. However, the size of the optical splitter module may be increased in other ways, or the design of the optical splitter module may be modified in other ways to accommodate the increased number of output optical fibers.

Other features of the optical splitter module 110 are also illustrated in FIG. 5B. One or more guide holes 132 may be provided in the optical splitter module 110. In the illustrated embodiment, four guide holes 132 are provided. The guide holes 132 may be threaded holes in some embodiments. The guide holes 132 may assist in the positioning of the optical splitter module 110, and the guide holes 132 may permit the optical splitter module 110 to be easily secured to another device. Additionally, in some embodiments, the optical splitter module 110 also includes a mount rail 134. In some embodiments, the mount rail 134 is configured to permit the optical splitter module 110 to engage with another optical splitter module. The mount rail 134 may be used in some embodiments to easily secure the optical splitter module 110 to some other device, such as within a corresponding slot or spot within an enclosure.

Additional details regarding splitter module 110 and splitter device 120 are disclosed in U.S. Pat. No. 7,349,616 granted on Mar. 25, 2008 and U.S. Pat. No. 10,955,634 granted on Mar. 23, 2021, the disclosures of which are incorporated by reference herein.

Referring briefly back to FIG. 3, multiple splitter modules 110 can be inserted into a terminal 100. As shown, terminal 100 includes a plurality of splitter modules 110 that are coupled to housing 106 of terminal 100, and each terminal 100 includes a corresponding input optical fiber 115 and a plurality of corresponding output optical fibers 117 that are terminated with connectors 104. In particular, in this embodiment, splitter modules 110 are connected in series as discussed in greater detail below, and connectors 104 comprise MPO connectors.

MPO connectors are typically available in 8, 12, or 24 optical fiber applications. As mentioned previously, in some embodiments, splitter device 120 of splitter modules 110 can split an optical signal from one input optical fiber 126 into thirty-two (32) or sixty-four (64) output optical fibers 128. The variation in number of output optical fibers 128 (depending on the splitter device 120) combined with the growing use of MPO connectors (connectors 104) can lead to termination challenges within terminal 100 as there may be output optical fibers 117 extending from the splitter device 120 that are unterminated or terminated with single fiber connectors. Stated another way, splitter modules 110 and their corresponding output optical fibers 117 may leave stranded output optical fibers 117 that are unterminated with certain multifiber connectors 104 (e.g., fiber counts of twelve (12), twenty-four (24), etc.) since the number of output optical fibers 117 is not divisible by the fiber count of multifiber connectors 104.

However, by connecting the splitter modules 110 in series as discussed in the present disclosure, a greater utilization of the output optical fibers 117 is achieved—i.e., a greater number of output optical fibers 117 are terminated with the multifiber connectors 104. This is advantageous as a greater density efficiency of connections is achieved within terminal 100, 200 by efficiently terminating output optical fibers 117 with multifiber connectors 104. In particular, multifiber connectors 104 that have a greater optical fiber allowance or fiber density can be used even if the split ratio of splitter module 110 is not divisible by fiber allowance of the multifiber connectors 104.

In the absence of the present disclosure, a multifiber connector 104 having a reduced fiber density would need to be used, and in turn, the spatial efficiency of the connector ports into which connectors 104 connect is reduced within terminal 100, 200. Moreover, there would be unutilized/unterminated output optical fibers that would be wasted due to lack of space/spatial inefficiency of connectors 104 within terminal 100, 200.

The present disclosure provides systematic allocation of output optical fibers from separate splitter devices into a multifiber connector(s) such that all available fiber ports of the multifiber connector are fully consumed.

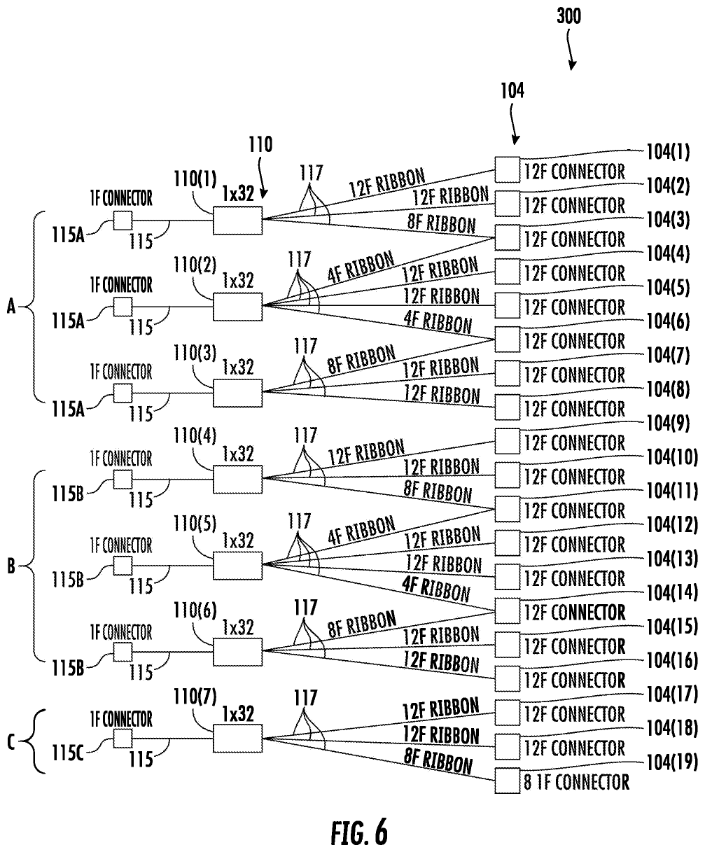

Table 1 below illustrates the termination of output optical fibers 117 when splitter modules 110 are connected in series. In this Table, optical splitter modules 110 are 1×32 splitters such that 32 output optical fibers 117 exit each splitter module 110. As shown, full termination of the output optical fibers 117 is achieved when three (3) or a multiple of three (3) optical splitter modules 110 are utilized within a terminal 100, 200. In particular, groupings of three (3) optical splitter modules 110 terminate all of the corresponding output optical fibers 117 when the three optical splitter modules 110 are connected in series as shown in FIG. 6 and discussed below.

TABLE 1

| | Number of | Number of | Number of remaining |
|---|---|---|---|
| Number of | Output | multifiber | unterminated fibers (i.e., |
| 1 × 32 | Optical | connectors | fibers to be terminated with |
| Splitters | Fibers 117 | (12-fiber MPO) | a single fiber connector) |
| 1 | 32 | 2 | 8 |
| 2 | 64 | 5 | 4 |
| 3 | 96 | 8 | 0 |
| 4 | 128 | 10 | 8 |
| 5 | 160 | 13 | 4 |
| 6 | 192 | 16 | 0 |
| 7 | 224 | 18 | 8 |
| 8 | 256 | 21 | 4 |
| 9 | 288 | 24 | 0 |
| 10 | 320 | 26 | 8 |
| Etc. | Etc. | Etc. | Etc. |

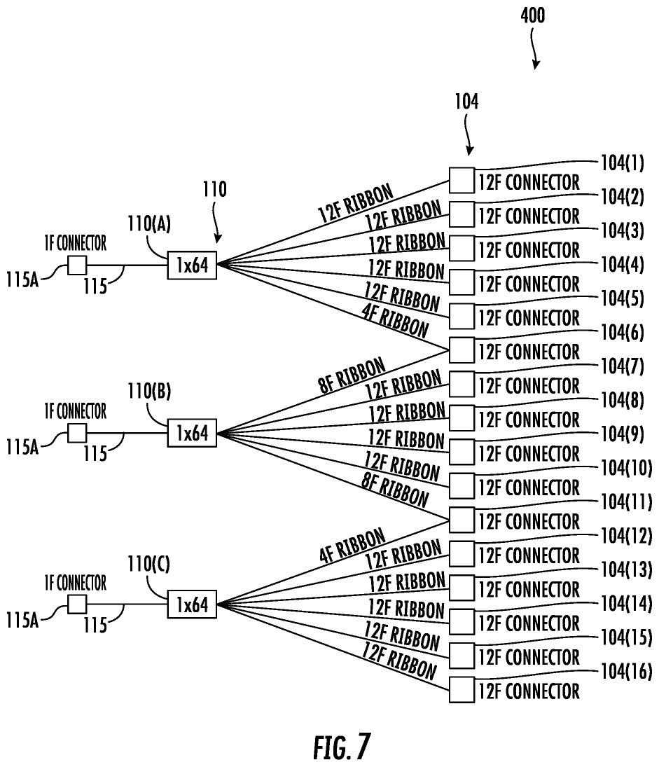

Similar to Table 1, Table 2 below illustrates the termination of output optical fibers 117 when splitter modules 110 are connected in series. In this Table, optical splitter modules 110 are 1×64 splitters such that sixty-four (64) output optical fibers 117 exit each splitter module 110. As shown, full termination of the output optical fibers 117 is achieved when three (3) or a multiple of three (3) optical splitter modules 110 are utilized within a terminal 100, 200. In particular, groupings of three (3) optical splitter modules 110 terminate all of the corresponding output optical fibers 117 when the three optical splitter modules 110 are connected in series as shown in FIG. 7 and discussed below.

TABLE 2

| | Number of | Number of | Number of remaining |
|---|---|---|---|
| Number of | Output | multifiber | unterminated fibers (i.e., |
| 1 × 64 | Optical | connectors | fibers to be terminated with |
| Splitters | Fibers 117 | (12-fiber MPO) | a single fiber connector) |
| 1 | 64 | 5 | 4 |
| 2 | 128 | 10 | 8 |
| 3 | 192 | 16 | 0 |
| 4 | 256 | 21 | 4 |
| 5 | 320 | 26 | 8 |
| 6 | 384 | 32 | 0 |
| Etc. | Etc. | Etc. | Etc. |

Referring now to FIG. 6, an example splitter module assembly 300 is illustrated for splitter modules 110 as used in terminal 100, 200. In this embodiment, splitter modules 110 divide the input optical signal from input optical fiber 115 into thirty-two (32) output optical fibers 117. Output optical fibers 117 are connected to connectors 104, and in this embodiment, connectors 104 are MPO connectors that each house twelve (12) output optical fibers 117. As mentioned previously, connector 104 can comprise alternate types of connectors (e.g., SC, LC, etc.) as well as alternate fiber count (e.g., fiber count other than 12 fibers).

As mentioned previously, splitter modules 110 are connected in series in splitter module assembly 200. As shown in FIG. 6, fiber routing pattern comprises seven (7) splitter modules 110. However, it is within the scope of the present disclosure that an alternate number of splitter modules 110 may be included in splitter module assembly 300 within terminal 100, 200.

In this embodiment, splitter modules 110 are grouped into Groups A, B, and C as shown where Groups A and B comprises three (3) splitter modules connected in series as discussed below.

As shown in FIG. 6, in Group A, a first splitter module 110(1) comprises thirty-two (32) output optical fibers 117 from an input optical fiber 115, and twenty-four (24) of those output optical fibers 117 are terminated at connectors 104(1), 104(2) (12 fiber MPO connector in this embodiment) with the remaining eight (8) output optical fibers 117 terminated within a separate connector 104(3). A second splitter module 110(2) within Group A also comprises thirty-two (32) output optical fibers 117 from an input optical fiber 115 where four (4) output optical fibers 117 of the thirty-two (32) output optical fibers 117 are terminated within connector 104(3) to fill the remaining bores of connector 104(3) and connect splitter modules 110(1) and 110(2) in series. Twenty-four (24) output optical fibers 117 of the remaining twenty-eight (28) output optical fibers 117 are terminated in connectors 104(4), 104(5) with the remaining four (4) output optical fibers 117 terminated within a separate connector 104(6). Similar to first and second splitter modules 110(1), 110(2), a third splitter module 110(3) within Group A comprises thirty-two (32) output optical fibers 117 from an input optical fiber 115 where eight (8) output optical fibers 117 of the thirty-two (32) output optical fibers 117 are terminated within connector 104(6) to fill the remaining bores of connector 104(3) and connect splitter modules 110(1), 110(2), 110(3) in series within splitter module assembly 300. The remaining output optical fibers 117 of are terminated with optical connectors 104(7), 104(8).

Group B follows a similar pattern as described above with respect to Group A where corresponding output optical fibers 117 of the three splitter modules 110 are terminated with connectors 104, and the three splitter modules 110 are connected in series.

Group C comprises a single splitter module 110 where twenty-four (24) of the thirty-two (32) output optical fibers 117 are terminated with two connectors 104, where the two connectors 104 are twelve fiber MPO connectors, and the remaining eight (8) output optical fibers are individually terminated with eight (8) single fiber connectors (e.g., SC, LC, etc.)

Groupings of three (3) splitter modules 110 within a splitter module assembly 300 enables termination of all output fibers 117 of said Group with connectors 104. Moreover, in Group C, all output optical fibers 117 are also terminated between the two MPO connectors 104 and the eight (8) single fiber connectors 104 as shown. In an alternate embodiment, the eight (8) single fiber connectors 104 can be replaced with a multifiber connector 104 where at least a portion of the bores of the multifiber connector include the remaining eight (8) fibers.

Referring now to FIG. 7, an example splitter module assembly 400 is illustrated for splitter modules 110 as used in terminal 100, 200. In this embodiment, splitter modules 110 divide the input optical signal from input optical fiber 115 into sixty-four (64) output optical fibers 117. Output optical fibers 117 are connected to connectors 104, and in this embodiment, connectors 104 are MPO connectors that each house twelve (12) output optical fibers 117. As mentioned previously, connector 104 can comprise alternate types of connectors (e.g., SC, LC, etc.) as well as alternate fiber count (e.g., fiber count other than 12 fibers).

As mentioned previously, splitter modules 110 are connected in series in splitter module assembly 400. As shown in FIG. 7, fiber routing pattern comprises three (3) splitter modules 110. However, it is within the scope of the present disclosure that an alternate number of splitter modules 110 may be included in splitter module assembly 400 within terminal 100, 200.

As shown in FIG. 7, a first splitter module 110(A) comprises sixty-four (64) output optical fibers 117 from an input optical fiber 115, and as shown, sixty (60) of those output optical fibers 117 are terminated at connectors 104(1)-(5) (12 fiber MPO connector in this embodiment) with the remaining 4 output optical fibers 117 terminated within a separate connector 104(6). A second splitter module 110(B) also comprises sixty-four (64) output optical fibers 117 from an input optical fiber 115 where eight (8) output optical fibers 117 of the sixty-four (64) output optical fibers 117 are terminated within connector 104(6) to fill the remaining bores of connector 104(3) and connect splitter modules 110(A) and 110(B) in series. As shown, forty-eight (48) output optical fibers 117 of the remaining fifty-six (56) output optical fibers 117 are terminated in connectors 104(7)-(10) with the remaining eight (8) output optical fibers 117 terminated within a separate connector 104(11). Similar to first and second splitter modules 110(A), 110(B), a third splitter module 110(C) comprises sixty-four (64) output optical fibers 117 from an input optical fiber 115 where four (4) output optical fibers 117 of the sixty-four (64) output optical fibers 117 are terminated within connector 104(11) to fill the remaining bores of connector 104(11) and connect splitter modules 110(A), 110(B), 110(C) in series within splitter module assembly 400. The remaining output optical fibers 117 of are terminated with optical connectors 104(12)-104(16) where connectors 104 comprise a twelve (12) fiber count connector.

Similar to FIG. 6, groupings of three (3) splitter modules 110 within a splitter module assembly 400 (as shown in FIG. 7) enables termination of all output fibers 117 of said Group with connectors 104.

While the above disclosure is directed to 1×32 and 1×64 splitter modules, it is within the scope of the present disclosure that the fiber routing patterns disclosed herein are applicable to alternate types of splitter modules, such as 1×128 splitter modules, etc.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A splitter module assembly for use within a terminal comprising:
a first splitter module having a first plurality of output optical fibers;
a second splitter module having a second plurality of output optical fibers;
wherein a portion of the first plurality of output optical fibers is terminated by a first connector; and
wherein a portion of the second plurality of output optical fibers is terminated by the first connector, thereby connecting the first splitter module and the second splitter module.

2. The splitter module assembly of claim 1, further comprising:
a third splitter module having a third plurality of output optical fibers;
wherein a second portion of the second plurality of output optical fibers is terminated by a second connector; and
wherein a portion of the third plurality of output optical fibers is terminated by the second connector, thereby connecting the second splitter module and the third splitter module.

3. The splitter module assembly of claim 1, wherein a remainder of the first plurality of output optical fibers are terminated by at least a third connector; and
wherein a remainder of the third plurality of output optical fibers are terminated by at least a fourth connector.

4. The splitter module assembly of claim 3, wherein the first, second, third, and fourth connectors comprise multifiber connectors that terminate all of the output optical fibers of the first, second, and third splitter modules are terminated.

5. The splitter module assembly of claim 4, wherein the multifiber connectors comprise MPO connectors.

6. A splitter module assembly for use within a terminal comprising:
a splitter module comprising a plurality of output optical fibers;
wherein a first portion of the plurality of output optical fibers is terminated by at least a first connector; and
wherein a second portion of the plurality of output optical fibers is terminated by at least a second connector;
wherein the first connector comprises a multifiber connector, and each second connector of the at least a second connector comprises a single fiber connector, whereby the plurality of output optical fibers are terminated by the first and the at least a second connector.

7. The splitter module assembly of claim 6, wherein the at least a second connector comprises a plurality of single fiber connectors, wherein the plurality of single fiber connectors terminate all optical fibers in the second portion of the plurality of optical fibers.

8. The splitter module assembly of claim 6, wherein the at least a first connector comprises a plurality of multifiber connectors, wherein the plurality of multifiber connectors terminate all optical fibers in the first portion of the plurality of optical fibers.

9. The splitter module assembly of claim 8, wherein the multifiber connectors comprise MPO connectors.

10. The splitter module assembly of claim 6, wherein the splitter module comprises a 1×32 or 1×64 splitter module.

11. A splitter module assembly for use within a terminal comprising:
a first splitter module having a first plurality of output optical fibers;
a second splitter module having a second plurality of output optical fibers;
wherein a first portion of the first plurality of output optical fibers is terminated by at least a first connector;
wherein a second portion of the first plurality of output optical fibers is terminated by a second connector;
wherein a first portion of the second plurality of output optical fibers is terminated by the second connector, thereby connecting the first splitter module and the second splitter module; and
wherein a second portion of the second plurality of output optical fibers is terminated by at least a third connector.

12. The splitter module assembly of claim 11, wherein the at least a first connector comprises a plurality of first connectors that terminate all of the optical fibers in the first portion of the first plurality of output optical fibers.

13. The splitter module assembly of claim 12, wherein the plurality of first connector and the second connector each comprise a multifiber connector.

14. The splitter module assembly of claim 11, wherein the at least a first connector and the second connector each comprise an MPO connector.

15. The splitter module assembly of claim 11, wherein the at least a third connector comprises a plurality of third connectors, wherein the plurality of third connectors terminate the second portion of the second plurality of output optical fibers.

16. The splitter module assembly of claim 15, wherein the plurality of third connectors comprises single fiber connectors, wherein the single fiber connectors individually terminate respective optical fibers of the second portion of the second plurality of output optical fibers.
